(19) United States
(12) Patent Application Publication
(10) Pub. No.: US 2012/0043404 A1
(43) Pub. Date: Feb. 23, 2012

(54) Safety and Control Device, System, and Method Thereof for a Waste Processing System

(76) Inventor: Michael Boyd Morey, Weidman, MI (US)

(21) Appl. No.: 13/318,142

(22) PCT Filed: Jul. 7, 2009
(86) PCT No.: PCT/US09/49754

§ 371 Date: Oct. 29, 2011

Related U.S. Application Data
(60) Provisional application No. 61/174,759, filed on May 1, 2009.

(51) Int. Cl. A01F 21/00; B02C 19/00

(52) U.S. Cl. 241/25; 241/37.5; 241/101.01

(57) ABSTRACT

A waste processing system includes a cutting system and a feed system, wherein the improvement relates to a safety and control system which comprises a foot actuated actuator having at least two operable positions, wherein the actuator is in communication with the waste processing system and is adapted to selectively control the operation thereof.

### CROSS REFERENCE To RELATED APPLICATION

This application claims the benefit of the filing date of U.S. provisional application Ser. No. 61/174,759 entitled “Safety Device, System, and Method Thereof for a Waste Processing System” which was filed on May 1, 2009 and which is herein incorporated by reference.

### BACKGROUND OF THE INVENTION

The present invention relates to waste processing systems, and more specifically to a safety device, a safety system, and method thereof for a waste processing system.

A variety of machines have been developed to recycle, reduce, or otherwise process wood and brush products. Included therein are machines that chip, cut, grind, or otherwise reduce waste (wood) products including, generally, chippers (disk and drum types), hammer mills, hogs, shredders, grinders, and forestry mowers.

These waste processing systems typically include an infeed system and a waste reducing system, wherein the infeed system is used for directing the waste material to the waste reducing system, the waste reducing system being used for reducing the waste material.

For example: wood chippers are used to reduce branches, trees, and other bulk wood products into small wood chips. A typical wood chipper often includes an infeed chute; a feed system which may be adapted for controlling the feed rate of wood products; a wood chipping mechanism; a drive system for the feed system and chipping mechanism; and a discharge chute. The infeed chute is typically a funnel-type conduit provided with a wide opening which tapers toward the feed system to converge the bulk wood/waste products toward the chipping mechanism and, through the action of the feed system, the bulk wood products are brought into contact with the chipping mechanism which grinds, flails, cuts, or otherwise reduced the wood and waste products into smaller pieces. The smaller pieces are then typically propelled into the discharge chute where they exit the wood chipper.

However, although these types of wood chippers are useful, if operated incorrectly they can become extremely dangerous. For example, the feed system, which is located at the narrowest point of the infeed chute, when operated incorrectly has been known to catch a user's clothing or worse, a limb of an operator. Another area that may become hazardous if operated incorrectly is the chipping mechanism which can rotate at high speeds in order to produce the high torque necessary to chip the wood and/or waste products. Further exacerbating the situation is that if something does become entangled in the feed system, the user may not be able to reach or activate a shutoff. Alternatively, a shutoff or other safety switch which is designed to activate when this emergency situation arises, may not activate due to various circumstances.

Therefore, there is a need in the art to provide a safety device, system, and method for a waste processing system that reduces or prevents the risks associated with these prior art waste processing machines. It is further desirable to provide a safety device for a waste processing system that is relatively inexpensive to manufacture, assemble, and is easily operable. Therefore, there is a need in the art to provide a safety device, system, and method for a waste processing system that overcome the above-identified disadvantages.

Accordingly, a need exists for novel systems and methods which have, among other advantages, the ability to provide for increased safety while being simple to operate. Therefore, systems and methods that solve the aforementioned disadvantages and having the aforementioned advantages are desired.

### SUMMARY OF THE PRESENT INVENTION

The aforementioned drawbacks and disadvantages of these former waste processing devices, systems, and methods have been identified and solutions are set forth herein.

A waste processing system according to the invention incorporates a control or safety device to stop or otherwise cut-off power to a feed system, a cutting mechanism, or a power system in order to reduce or prevent injury to an operator or the equipment. Alternatively, a device to reverse the feed system, cutting mechanism, or both can be accomplished. The improvement may be utilized in conjunction with any waste reducing machinery, either new or existing, and in one exemplary embodiment, the invention comprises a waste processing system including rotary feed wheels which are powered hydraulically, and in an emergency situation, the system automatically actuates to interrupt or cut-off the supply of hydraulic fluid to the feed wheels of the waste processing system. In another aspect of the invention, the device reverses the flow of hydraulic fluid thereby reversing the direction of rotation of the feed system. The novel devices, systems, and methods disclosed herein can be incorporated into any waste reducing machinery regardless of the drive system, and can be used to cut-off, interrupt, or reverse the power system, the feed system, the cutting blades, or any other primary systems of these waste processing machines. As such, the equipment and operators of these systems are provided with additional protection and safety.

In one embodiment, the waste processing system comprises a cutting system and a feed system, wherein the improvement relates to a safety system which comprises an actuator having at least two operable positions, the actuator being in communication with the waste processing system and adapted to selectively control the operation thereof. Further, the actuator is positionable about the waste processing system.

Another aspect of the present invention includes a waste processing system comprising a cutting system and a feed system, wherein the improvement relates to a safety system which comprises an actuator. The actuator is disposed on the waste processing system, below a horizontal reference line defined by a top of an infeed chute. The actuator has at least two operable positions and is operably connected with the waste processing system to allow operation of the waste processing system upon positioning the actuator in a first position.

In another aspect of the present invention, a waste processing system comprises a cutting system and a feed system, wherein the improvement relates to a safety system which includes an actuator disposed on the waste processing system below a horizontal reference line defined by a top of an infeed chute. The actuator has at least two operable positions and is operably connected with the waste processing system and adapted to selectively control operation thereof.

And still in another aspect of the present invention, a wood chipper comprises a foot activated actuator having at least two operable positions, wherein the foot activated actuator is operably connected with at least one of the cutting system and the feed system to restrict operation of the at least one of the cutting system and the feed system when the foot activated actuator is in one of the two operable positions.

In yet another embodiment, a wood chipper comprises an infeed chute and a discharge chute; a feed system disposed between the infeed chute and the discharge chute; a cutting system disposed between the feed system and the discharge chute; and a remotely positionable actuator which is configured to shut off at least one of the feed system, the cutting system, and a power system.

In still another embodiment, a method of operating a waste processing system is disclosed which includes: providing a waste processing system comprising a cutting system, a feed system, and a power system; providing a safety system comprising an actuator disposed on the waste processing system below a horizontal reference line defined by a top of an infeed chute and adapted to permit operation of the cutting system, the feed system, and the power system when the actuator is in a first predetermined state, and adapted to interrupt operation of at least one of the cutting system, the feed system, and the power system when the actuator is in a second predetermined state; positioning the actuator in a first predetermined state; operating the cutting system, the feed system, and the power system in response to the actuator being in a first predetermined state; and interrupting operation of at least one of the cutting system, the feed system, and the power system in response to the actuator being in a second predetermined state.

In yet another embodiment, a method of operating a waste processing system includes: providing a waste processing system comprising a cutting system, a feed system, and a power system; providing a safety system comprising a foot activated actuator adapted to permit operation of the cutting system, the feed system, and the power system when the foot activated actuator is in a first predetermined state, and adapted to interrupt operation of at least one of the cutting system, the feed system, and the power system when the foot activated actuator is in a second predetermined state; determining if the foot activated actuator is in a first predetermined state or a second predetermined state; operating the cutting system, the feed system, and the power system in response to the actuator being in a first predetermined state and requiring that the actuator be continuously maintained in the first predetermined state for operation thereof; and interrupting operation of at least one of the cutting system, the feed system, and the power system in response to the actuator being in a second predetermined state.

In still another embodiment, a waste processing system is disclosed and includes a cutting system and a feed system, wherein the improvement relates to a lower feed control bar which comprises a lower feed control bar disposed below a horizontal plane defined by a top of an infeed chute. The lower feed control bar is operably attached to an actuator having at least two operable positions, and the actuator is in communication with the waste processing system and adapted to selectively control the operation thereof. In yet another embodiment, a control for a waste processing system comprising a cutting system and a feed system is disclosed wherein the control comprises an actuator adapted to be mountably disposed below a horizontal plane defined by a top of an infeed chute, and the actuator has at least two operable positions. The actuator is adapted to communicate with at least one of a cutting system and a feed system of a waste processing system for selective control thereof.

And, in yet another embodiment, a control for use in combination with an existing waste processing system comprising a cutting system and a feed system is disclosed and includes an actuator adapted to be mountably disposed below a horizontal plane defined by a top of an infeed chute of an existing waste processing system, wherein the actuator has at least two operable positions. Further, the actuator is adapted to communicate with at least one of a cutting system and a feed system of a waste processing system for selective control thereof when installed thereon. Further yet, the actuator is adapted to be normally biased to a second position, whereas a first position must be continuously maintained by an operator for operation of the existing waste processing system.

Other objects, advantages, and features of the invention will become apparent upon consideration of the following detailed description and drawings. As such, the above brief descriptions set forth, rather broadly, the more important features of the present novel invention so that the detailed descriptions that follow may be better understood and so that the contributions to the art may be better appreciated. There are of course additional features that will be described hereinafter which will form the subject matter of the claims.

In this respect, before explaining the preferred embodiment of the disclosure in detail, it is to be understood that the disclosure is not limited in its application to the details of the construction and the arrangement set forth in the following description or illustrated in the drawings. To wit, the waste processing system, device, and method of the present disclosure are capable of other embodiments and of being practiced and carried out in various ways. Also, it is to be understood that the phraseology and terminology employed herein are for description and not limitation. Where specific dimensional and material specifications have been included or omitted from the specification, or the claims, or both, it is to be understood that the same are not to be incorporated into the claims, unless so claimed.

As such, those skilled in the art will appreciate that the conception upon which this disclosure is based may readily be used as a basis for designing other structures, methods, and systems for carrying out the several purposes of the present invention. It is important therefore that the claims are regarded as including such equivalent constructions, as far as they do not depart from the spirit and scope of the present invention.

Further, the purpose of the Abstract is to enable the United States Patent and Trademark Office, the public generally, and especially the scientists, engineers, and practioners in the art who are not familiar with the patent or legal terms of phraseology, to learn quickly, from a cursory inspection, the nature of the technical disclosure of the application. Accordingly, the Abstract is intended to define neither the invention nor the application, which is only measured by the claims, nor is it intended to be limiting as to the scope of the invention in any way.

These and other objects, along with the various features and structures that characterize the invention, are pointed out with particularity in the claims annexed to and forming a part of this disclosure. For a better understanding of the waste processing system of the present disclosure, its advantages, and the specific traits attained by its use, reference should be made to the accompanying drawings and other descriptive matter in which there are illustrated and described the preferred embodiments of the invention.

As such, while embodiments of the waste processing system are herein illustrated and described, it is to be appreciated that various changes, rearrangements, and modifications may be made therein without departing from the scope of the invention as defined by the claims.

### BRIEF DESCRIPTION OF THE DRAWINGS

As a compliment to the description and for better understanding of the specification presented herein, 11 pages of drawings are disclosed with an informative, but not limiting, intention.

FIG. 1 is a perspective view of a prior art wood chipper;

FIG. 2 is a side view of an embodiment of a waste processing system according to the present invention;

FIG. 3 is a partial perspective view of the infeed chute of the waste processing system of FIG. 2, illustrating one embodiment of the present invention;

FIG. 4 is a partial perspective view of an infeed chute of a waste processing system, illustrating an alternate embodiment of the present invention;

FIG. 5 is a partial perspective view of an infeed chute of a waste processing system, illustrating an alternate embodiment of the present invention;

FIG. 6 is a partial perspective view of an infeed chute of a waste processing system, illustrating an alternate embodiment of the present invention;

FIG. 7 is a partial perspective view of an infeed chute of a waste processing system, illustrating an alternate embodiment of the present invention, in a use position;

FIG. 8 is a partial perspective view of an infeed chute of a waste processing system, illustrating the embodiment of FIG. 7, in a stored position;

FIG. 9 is a partial perspective view of an infeed chute of a waste processing system, illustrating an alternate embodiment of the present invention;

FIG. 10 is a partial perspective view of an infeed chute of a waste processing system, illustrating an alternate embodiment of the present invention;

FIG. 11 is a partial perspective view of an infeed chute of a waste processing system, illustrating an alternate embodiment of the present invention;

FIG. 12 is a partial perspective view of an infeed chute of a waste processing system, illustrating an alternate embodiment of the present invention;

FIG. 13 is a partial perspective view of an infeed chute of a waste processing system, illustrating an alternate embodiment of the present invention;

FIG. 14 is a partial perspective view of an infeed chute of a waste processing system, illustrating an alternate embodiment of the present invention;

FIG. 15 is a partial perspective view of an infeed chute of a waste processing system, illustrating an alternate embodiment of the present invention;

FIG. 16 is a partial perspective view of an infeed chute of a waste processing system, illustrating an alternate embodiment of the present invention;

FIG. 17 is a partial perspective view of an infeed chute of a waste processing system, illustrating an alternate embodiment of the present invention;

FIG. 18 is a partial perspective view of an infeed chute of a waste processing system, illustrating an alternate embodiment of the present invention;

FIG. 19 is a partial perspective view of an infeed chute of a waste processing system, illustrating an alternate embodiment of the present invention;

FIG. 20 is a flow chart illustrating a method of operating a waste processing system according to one embodiment of the present invention;

FIG. 21 is a diagrammatical view of one embodiment of the safety device of the present invention;

FIG. 22 is a diagrammatical view of one embodiment of the safety device of the present invention;

FIG. 23 is a diagrammatical view of one embodiment of the safety device of the present invention;

FIG. 24 is a diagrammatical view of one embodiment of the safety device of the present invention;

FIG. 25 is a diagrammatical view of one embodiment of the safety device of the present invention;

FIG. 26 is a diagrammatical view of one embodiment of the safety device of the present invention;

FIG. 27 is a diagrammatical view of one embodiment of the safety device of the present invention;

FIG. 28 is a diagrammatical view of one embodiment of the safety device of the present invention.

### DETAILED DESCRIPTION OF THE PREFERRED EMBODIMENT

The best mode for carrying out the invention is presented in terms of the preferred embodiment, wherein similar referenced characters designate corresponding features throughout the several figures of the drawings.

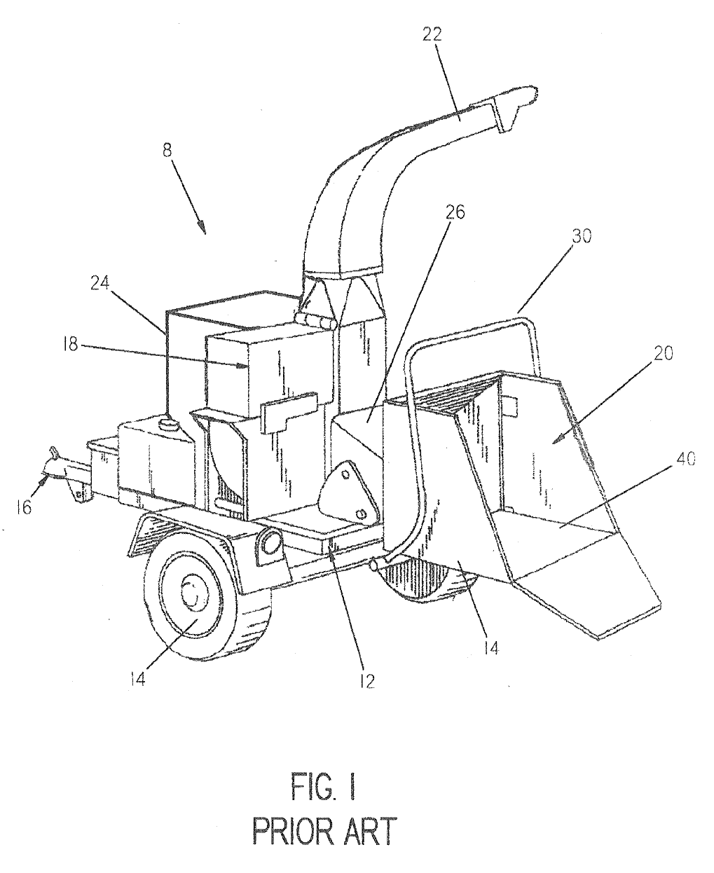

For purposes of description herein, the terms “upper”, “lower”, “right”, “left”, “rear”, “front”, “vertical”, “horizontal”, and derivatives thereof, shall relate to the orientation illustrated in FIG. 1. However, it is to be understood that the invention may assume various alternative orientations, except where expressly specified to the contrary. It is also to be understood that the specific devices and processes illustrated in the attached drawings and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

Reference will now be made in detail to the present preferred embodiments of the invention, examples of which are illustrated in the accompanying drawings. Wherever possible, these same referenced numerals will be used throughout the drawings to refer to the same or like parts. Like features between the various embodiments utilize similar numerical designations. Where appropriate, the various similar features have been further differentiated by an alphanumeric designation, wherein the corresponding alphabetic designator has been changed. Further, the dimensions illustrated in the drawings (if provided) are included for purposes of example only and are not intended to limit the scope of the present invention. Additionally, particular details in the drawings which are illustrated in hidden or dashed lines are to be considered as forming no part of the present invention.

As used herein, the term wood and wood products are meant to be used and defined in their broad, general, and ordinary sense, and the terminology is meant to include trees, brush, trunks, stems, branches, leaves, or the like, or anything else that could otherwise be recycled, reduced, or otherwise processed, and further includes non-naturally occurring or manufactured wood products such as lumbar, pallets, or other manufactured products that could otherwise be recycled, reduced, or otherwise processed, as is generally known within the art.

As used herein, the term waste processing system is meant to be used and defined in its general and ordinary sense. To wit, systems that recycle, reduce, or otherwise process wood products. Included therein are machines that chip, cut, grind, or otherwise reduce wood waste products and include, generally, chippers and/or shredders. Of course, this is not meant to be limiting in any manner and these systems may take on numerous configurations, and may be used for numerous purposes as is generally known within the art.

Generally, while waste processing machines and wood chippers are commonly known and regularly utilized to reduce branches, trees, and other bulk wood products into smaller wood chips, if incorrectly operated they can be extremely dangerous.

Accordingly, a need exists for safety devices, systems, and method that are, among other things, relatively inexpensive, provide for increased safety, and are easily operable. Therefore, a safety system that solves the aforementioned disadvantages and having the aforementioned advantages is desired and, disclosed herein.

While not meant to be limiting in any manner, it is envisioned that this system may offer the following advantages: The safety system may be designed to interact with, cooperate with, or control one or more other safety systems of the waste processing machine, whether existing or developed in future. For example, in one embodiment, the invention will be configured in such a manner so as to allow for the independent operation of the waste processing system such that when the safety switch or actuator of the present invention is in a first state, the functions and operation of the waste processing system will be normal and, for example only, all other (existing) safety systems disposed on the waste processing system will operate as they would normally operate. However, when the switch or actuator is in a second state, the waste processing system will not operate as normal and, again for example only, the feed system may be restricted in its operation; In one embodiment the inventive system utilizes mechanical devices in its operation and therefore, may be more reliable than electrical and/or electronic devices. For example, the safety device may operate a mechanical valve disposed within the hydraulics of a feed system in order to operate, make inoperable, and/or reverse the feed system. Of course, electrical and electronic devices may also be utilized; In another embodiment, the safety device is retrofitable to existing waste processing systems; In another embodiment, the safety device is configured so as to require the device to be present and/or connected for operation of the waste processing system and therefore, the processing system does not allow operation of the system without the safety device; In another embodiment, the safety device is configured so as to require the device to be in a predetermined state (i.e., a first state) for normal operation of the waste processing system. Otherwise, the waste processing system will not operate as normal; In another embodiment, the safety device is designed as a foot actuated device; In another embodiment, the safety device is designed to be easily connected and removed from the processing system and further, is positionable thereto. For example, the device may be pressure activated mat that may be connected and removed for convenience and safety; In another embodiment, the safety device is designed to be used as a feed control bar. Herein the safety device may be utilized as a feed control bar, either in conjunction with an existing hand feed control bars, or exclusively and as a replacement thereto. For example, in a foot actuated embodiment, the safety device may be utilized to start and stop the feed wheels of the system, thereby controlling the feed of the waste products from a foot actuated pedal. Again, and for example only, in one embodiment the operator may position the material to be chipped into the chute and then move to the side of the chute, away from the open chute, and operate the chipper without being exposed to the open infeed chute. This not only reduced the likelihood that the operator may be entangled therein, thereby increasing safety, it is also easier to operate the system in this configuration. Of course, the safety device could be used to operate and control other systems either exclusively, or in conjunction with the feed wheels; In yet another embodiment, more than one of these safety devices can be utilized. For example, a front and a rear foot actuated bar can be utilized and, these bars may operate in unison or independently. Still further, they may both be configured to control the feed system, or to control differing systems. In one preferred embodiment and when foot actuated devices are utilized, both foot actuated devices control the feed system (e.g., as a feed bar) and operate as a safety device; In another embodiment, the safety device is designed to be easily connected or linked to the system. For example, plugged into the waste processing system through a connector.

While existing safety systems are designed to increase the operational safety of these mobile or trailerable waste processing machines, these existing safety features are designed to activate only in response to a particular occurrence or situation and therefore, may not activate under numerous, other circumstances. For example, a number of existing safety systems rely on the operator grabbing, pulling, or otherwise activating the safety feature in order to work. However, the particular situation for which the safety device is designed to operate within may either not arise; be deactivated or otherwise rendered inoperable by branches, brush, or the like; or be deactivated by the operator. Contrarily, the safety device of the present invention overcomes these existing problems. For example, with a foot controlled device as described further herein, if the operator is in trouble (pulled into or towards the feed chute or system) upon being lifted, moved, or otherwise re-positioned, the safety device would activate and may shut off the feed system in order to prevent injury. As such, the device can be configured to rely on the position of the operator being within a safe zone, as opposed to relying on the operator themselves for actuation.

Referring now to FIG. 1, a prior art wood chipper 8 is illustrated. During the operation of chipper 8, it may become necessary to abruptly stop one or more components of the system. For example, in the event of an emergency wherein a portion of a user's body or clothing becomes captured by the feed system (e.g., the feed wheels), the user may be drawn toward or into the system. Therefore, in such an emergency situation, it becomes desirable to immediately stop and/or reverse at least one of the cutting system 18, the feed system 26, and the power supply or engine 24. This may be accomplished for example by removing, interrupting, or otherwise shutting off the power supply to the cutting system 18, the feed system 26, or both.

For example, it is generally known to provide a wood chipper with a feed control bar 30 which requires the operator to move the bar in order to operate the feed system. Feed control bar 30 may comprise, for example, a multi-position switch wherein the bar must be moved by the operator and held or biased rearwardly (e.g., towards opening 40 of infeed chute 20) in order for the feed system 26 to be operable. As the bar will typically be normally biased towards a position which does not allow operation of the feed system, if for any reason the operator lets go of the bar, the bar will move to its normally biased position and the feed system will cease to operate. As such, in an emergency situation, once an operator releases feed control bar 30, the bar returns to its normally biased position and the feed system is deactivated.

While these prior art systems have reduced the risks associated with the operation of these waste processing systems, they are not fool proof. For example, if proper procedures and operations are not followed, it is possible for these systems to become deactivated or overridden. Accordingly, a need exists for improved safety systems, feed controls, and methods thereof which provide additional protection and improvements.

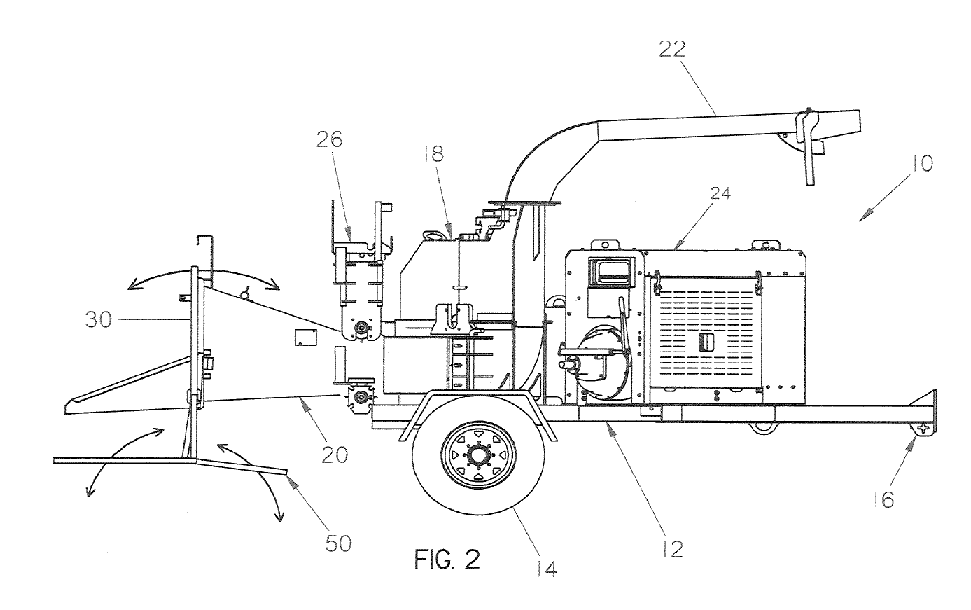

The disadvantages and drawbacks of the prior art are overcome through the waste processing system of the present invention, wherein one preferred embodiment is disclosed. Referring now to FIG. 2, one embodiment of a waste processing system is shown generally at 10 and includes a frame 12 supported by a pair of wheels 14, and a trailer hitch 16 in order to allow the waste processing system to be transported by a vehicle. Supported on the frame 12 are a cutting system 18, an infeed chute 20, and a discharge chute 22. A power system 24, typically comprising an internal combustion engine, is also mounted on frame 12 to provide power to both a feed system 26 and the cutting system 18. As is generally known, operation of waste processing system 10 typically comprises providing power to the cutting system 18 and the feed system 26 through power supply 24, whereby feed system 26 feeds or supplies cutting system 18, and cutting system 18 is used to reduce or otherwise process the wood products which are then dispensed through discharge chute 22. Cutting system 18 may comprise a rotary cutting mechanism or blade (not shown), and feed system 26 may generally comprise a feed wheel system (also not shown).

It should be understood that waste processing system 10 may comprise any suitable waste reducing machinery such as the trailerable wood chipper as seen in FIG. 1, or any other, typically, movable machinery used to chip, grind, cut, or otherwise reduce bulk products. Further, while the preferred embodiment incorporates a pair of opposed, horizontally aligned feed wheels, it is understood that any feed system may be utilized. It should be further understood that this disclosure describes the structure and operation of a safety and control system 50 with respect to a hydraulic system, however, other powering systems may also be utilized. Still further, the waste processing system 10 is described and illustrated as being operated by an internal combustion engine, however, the system may also be powered by any other suitable method, including, but not limited to, electricity, gas, diesel, or a power take-off from an auxiliary power source, without departing from the scope of this invention. In a broader sense, FIG. 2 illustrates an embodiment of the safety and control system 50 wherein is shown a waste processing system 10 including the primary systems of a cutting system 18, a feed system 26, a power supply or source 24. In general, cutting system 18, feed system 26, and power source 24 are known in the art. Further, it is to be understood that numerous configurations of these known devices may be used and the description herein is not meant to be limiting with respect to these systems, unless otherwise noted, and equivalent components may be used.

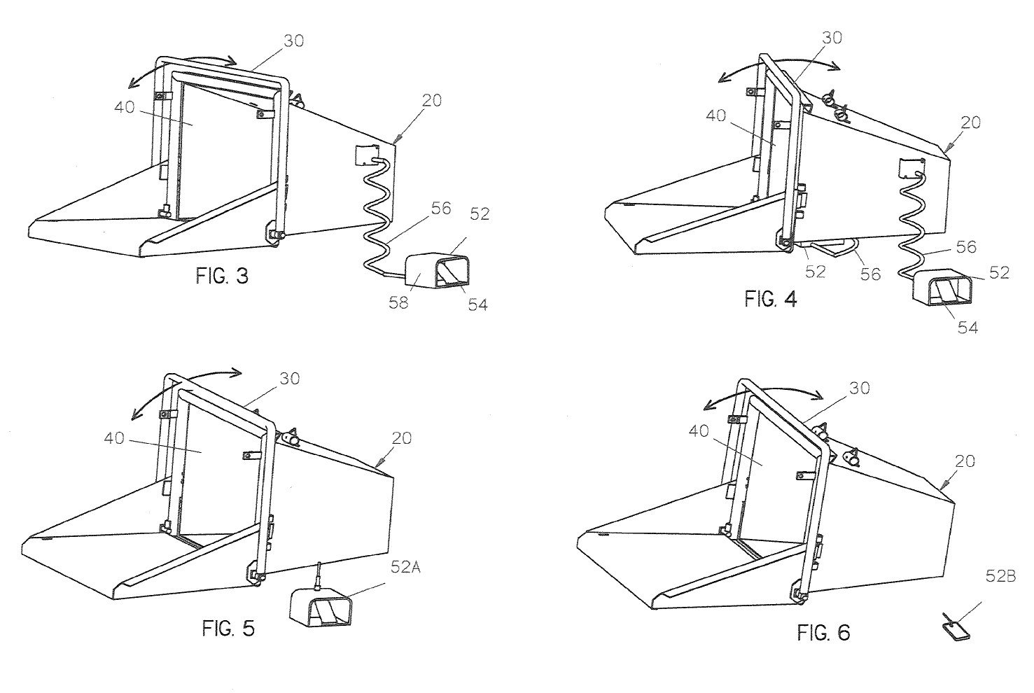

Referring now to FIG. 3, another embodiment of the safety and control system 50 is illustrated wherein is shown a safety and control system 50 which comprises an actuator 52 having at least two operable positions (e.g., on or off). The safety and control system 50 and actuator 52 are operably connected to or otherwise in communication with one or more of the primary systems of waste processing system 10, and are adapted to selectively control the operation thereof. For illustrative purposes only, the selective control of these systems may comprise selectively powering, driving (forward or reverse), interrupting, stopping, braking, or otherwise operating one or more of the primary systems of the waste processing system including, for example, the power supply 24, the cutting system 18, and the feed system26. As illustrated, actuator 52 is positionable about waste processing system 10 and as such, actuator 52 may be disposed, moved, or otherwise positioned off of (or away from) waste processing system 10 in a manner that facilitates the operators particular needs, desires, or requirements.

In one embodiment, actuator 52 is configured to be actuated by an operator's foot. In the embodiment illustrated by FIG. 3, actuator 52 also comprises a foot pedal 54 and may be configured to be operable between a first predetermined state and a second predetermined state. For example, the first predetermined state may be operably connected to waste processing system 10 so as to provide continuity or a closed switch when an operator moves or positions pedal 54 in anything other than its normal state; while the second predetermined state may be configured to provide an open switch when the pedal 54 is not moved or positioned. For example, this may be accomplished through a normally off momentary switch or valve. In this manner, when pedal 54 is depressed by the operator the safety and control system 50 provides a closed circuit and the primary systems of waste processing system 10 operate normally. However, when pedal 54 is released from the depressed state, or otherwise in a normal or unmoved state, the safety and control system 50 is configured and operably connected to one or more of the primary systems of waste processing system 10 so as to prevent, stop, or reverse the operation of one or more of the cutting system 18, the feed system 26, and the power system 24. This operational control, interruption, or stoppage of one or more of the cutting system 18, the feed system 26, and the power system 24 may be accomplished by having safety and control system 50 in direct and operable communication with the cutting system 18, the feed system 26, and the power system 24, or through one or more other components, and for example only, one or more other safety devices.

For example only, when pedal 54 is depressed, corresponding to the actuator being in a first predetermined state, normal operation of waste processing system 10 ensues. However, when pedal 54 is not depressed, moved, or otherwise activated, corresponding to the actuator being in a second predetermined state, operation of feed control bar 30 is selectively restricted. As such, normal operation of feed control bar 30 is permitted when the actuator is in the first state (e.g., pedal 54 is depressed), and restriction in the operation of feed control bar 30 occurs when the actuator is in the second predetermined state (e.g., pedal 54 is released). In further example, when in the second predetermined state, feed control bar 30 could be interrupted and restricted from activating feed system 26 or further, reversing the feed system. Alternatively, when actuator 52 is in the second predetermined state, the feed system 26 may be directly shut-off by actuator 52, or directly made to operate in a reverse mode.

Other alternate embodiments, configurations, and operable connections may comprise a safety and control system 50 which is adapted: to permit operation of both the cutting system 18 and the feed system 26 when the actuator is in the first predetermined state; to permit operation of at least one of the cutting system 18 and the feed system 26 when the actuator is in the first predetermined state; to interrupt operation of at least one of the feed system 26 and the cutting system 18 when the actuator is in the second predetermined state; to interrupt operation of the cutting system 18 and to permit motive operation of the feed system 26 in a reverse direction when the actuator is in the second predetermined state; to restrict operation of at least one of the cutting system 18 and the feed system 26 when the actuator is in the first or second predetermined state, as required. For example by controlling access to other controllers, safety devices and the like; to selectively control operation of at least one of the cutting system 18 and the feed system 26 when the actuator is in the first or second predetermined state; or to selectively brake at least one of the cutting system 18 and the feed system 26 when the actuator is in the second predetermined state.

Safety and control system 50 may be operably connected or in communication with one or more primary systems, subsystems, or components of waste processing system 10 and more particularly, with the feed system 26, the cutting system 18, and the power system 24 in any known manner and for example only, electrically, physically, or hydraulically. For example, a wired or electric/electronic connection 56. Alternatively, in a hydraulic configuration, actuator 52 may be adapted to operate a diverter valve which is configured to redirect a flow of hydraulic fluid from one or more of the primary systems of the waste processing system 10, more particularly, cutting system 18 or feed system 26, toward a hydraulic reservoir when the actuator is in the second predetermined state.

Referring now to FIG. 4, there is shown an alternate embodiment comprising a pair of actuators 52. In the particular illustrated embodiment, a pair of foot pedals 54 is provided and, either alone or in combination, may be operable as described above. For example, safety and control system 50 may be operably configured to require activation of a single actuator 52, or a pair of actuators 52. As such, actuators 52 could be disposed on either side of the infeed chute 20 for independent operation, or dual operation by multiple operators, or positioned so as to require operation in unison by a single operator.

Referring now to FIG. 5, there is shown an alternate embodiment comprising a foot activated actuator 52A which is wirelessly communicating with or otherwise connected to waste processing system 10.

As shown generally in FIGS. 3-5, one embodiment of safety and control system 50 generally includes an actuator 52 comprising a foot pedal 54, connected to waste processing system 10 through a wired connection 56. Also illustrated is a guard or cover 58 which assists in preventing accidental operation of actuator 52. For example, through accidental operation via the operator, or accidental operation via branches, debris, and the like associated with the chipping or wood reducing environment. Actuator 52 is operably connected to waste processing system 10 as described herein and again, for example only, may be operably connected so as to selectively control operation, directly or indirectly, of at least one of the cutting system 18, power system 24, and feed system 26.

Safety and control system 50 may be operably connected to and communicate with waste processing system 10 mechanically, electrically, and hydraulically. For example, safety and control system 50 may be operably connected to power source 24 so as to deactivate the power source when desired, and this connection could be a physical connection such as a cable, may be an electrical connection such as an electronic switch or alternatively, the connection may comprise a hydraulic connection. Generally, actuator 52 may operate, switch, actuate, or otherwise communicate a desired state in any known manner and may comprise, for example, any suitable mechanism such as a button, switch, solenoid, or the like.

By utilizing a foot actuated safety device, either alone or in conjunction with feed control bar 30, increased safety in operation of these waste processing machines is accomplished. For example, the feed system, located at the narrowest point of the infeed chute, is a dangerous area and when operated improperly can cause injury to an operator (or the machine itself). Further exacerbating the situation is that if an operator or other object were to become entangled in the feed system, the operator may not be able to reach or activate a shutoff. As such, the shutoff or other safety switch which is designed to activate when this emergency situation arises, may not activate due to various circumstances. However, with a foot actuated device, unless the proper force is applied to the pedal, the system will automatically respond (stop). For example, if an operator were to be drawn into the machine, upon the operators weight being lifted from the pedal (e.g., as they were drawn into the machine) the system would automatically and quickly be shut down, regardless of the operators response, or lack thereof.

FIG. 6 illustrates yet another embodiment of a remotely positionable actuator 52B. In this configuration, activation of the safety and control system 50 is accomplished wirelessly and may be hand activated. Of course, this embodiment could also communicate with the waste processing system 10 through a wired connection.

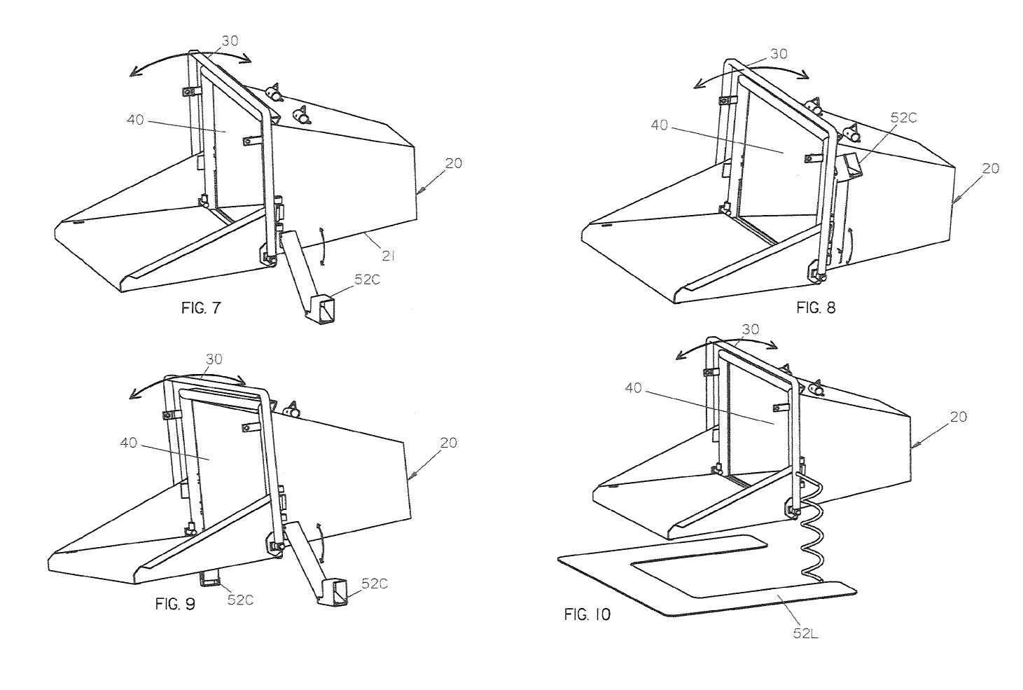

As illustrated by FIG. 7, there is shown yet another alternate embodiment comprising a waste processing system 10 including a foot activated actuator 52C. In this embodiment, actuator 52C may be adapted to selectively control operation of the waste processing system 10 as described herein and is disposed on waste processing system 10. Actuator 52C is adapted to be actuated by an operator's foot and is not remotely positionable. Rather, actuator 52C is attached or otherwise connected to one or more sides of the waste processing system 10, for example, the side of infeed chute 20. Actuator 52C may be rotatable from an in-use or first position (FIG. 7) which may extend below a bottom 21 of infeed chute 20; to a stored or second position (FIG. 8) which does not extend below bottom 21 and allows for storage and transportation of the waste processing system 10. FIG. 9 illustrates yet another embodiment comprising a pair of actuators 52C.

As illustrated by FIG. 10, there is shown yet another alternate embodiment comprising a waste processing system 10 including a pressure pad or mat 52L. In this embodiment, actuator 52L is adapted to selectively control operation of the waste processing system 10 as described herein, and is disposed on the ground: for example near infeed chute 20. Actuator-pad 52L is adapted to be actuated when an operator is positioned anywhere thereon. While this embodiment may comprise any shape or size, in one embodiment the mat or pad 52L is configured to be U-shaped and is disposed around infeed chute 20 so as to be operable from any side. Of course, a smaller pad for positioning and operation on one side may also be utilized.

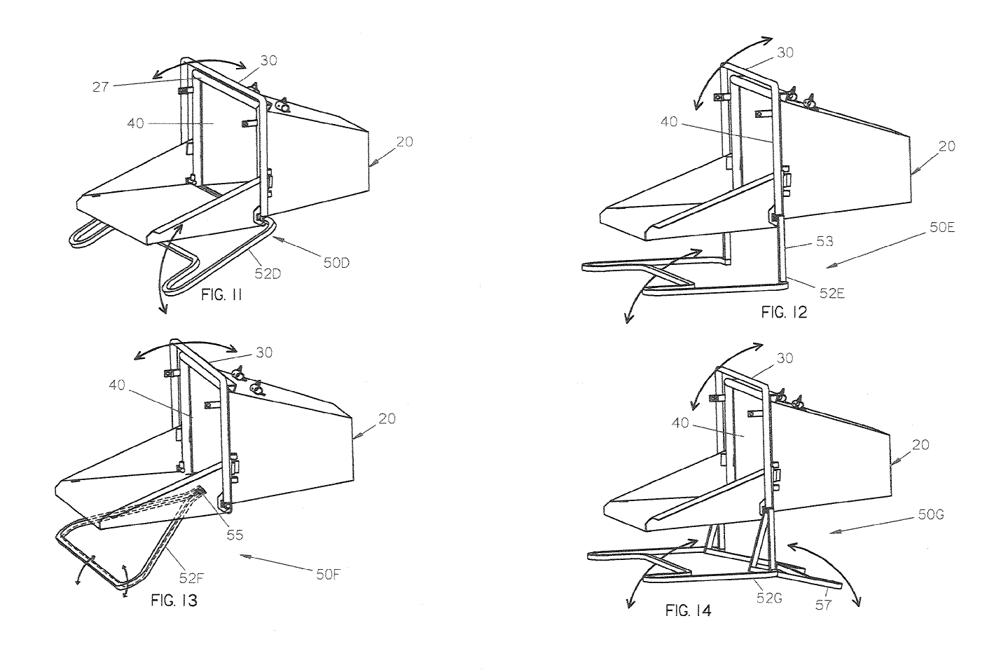

Referring to FIG. 11, there is shown yet another embodiment of a safety and control system 50D comprising a foot activated bar actuator 52D operatively connected to (for example only) infeed chute 20. The configuration and operable characteristics are similar to the previous embodiments described herein, and may be either directly in communication with one or more of the primary systems of waste processing system 10, or indirectly in communication therewith. For example, safety and control system 50D may be operatively in communication to permit normal operation of waste processing system 10 when actuator 52D is in a first predetermined state (e.g., positioned or activated downwardly), and to selectively restrict control of the feed control bar 30 when the actuator 52D is in a second predetermined state (e.g., normally biased or not activated). Additionally, one preferred embodiment utilizes an actuator bar 52D which is operatively connected to the infeed chute 20 such that the actuator bar 52D is disposed below the infeed chute 20. Referring to FIG. 12, an embodiment 50E is illustrated which is similar to FIG. 11. This embodiment utilizes an extension 53 to operably connect actuator 52E to the waste processing system 10.

It is worth noting that the safety and control system 50 and various actuators may be operatively connected to the waste processing system in numerous manners (e.g., mechanical, electrical, hydraulic) and may be disposed anywhere on, along, or underneath the waste processing system. Furthermore, in various preferred embodiments and especially those that may be operable via an operators foot, the safety and control system 50 and more particularly the actuators, bars, pedals, and the like thereof will generally be disposed below a top 27 of the infeed chute.

In another embodiment (FIG. 13), a safety and control system 50F is configured to be operable from in front of the infeed chute 20 (e.g., operable up and down), as well as operable from both sides of the infeed chute (e.g., rotatable from the side). Still further, this embodiment operates from a single pivot point 55. For example, actuator bar 52F may be operatively connected at a single location, centrally, to the bottom of the infeed chute 20.

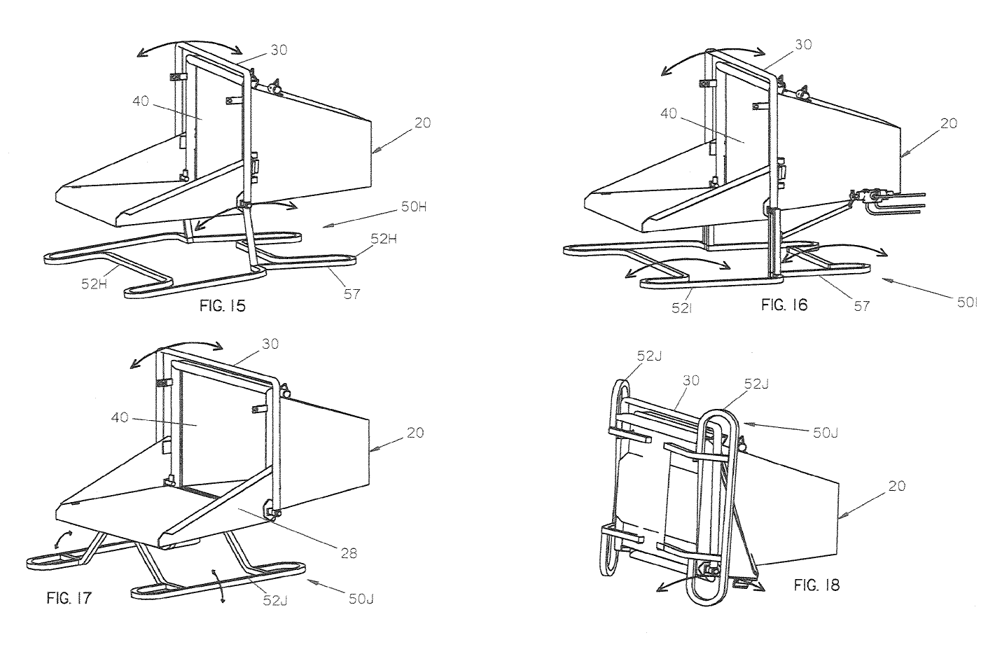

In yet another embodiment (FIG. 14), the safety device 50G further includes a second or auxiliary actuator 57 configured to be operable from both sides of the infeed chute 20, and in this particular embodiment is disposed rearwardly and adjacent to the first actuator 52G. While these actuators may be configured to operate in unison as illustrated by 50H in FIG. 15, as illustrated in FIG. 14, they are configured to operate independently of one another. FIG. 16 includes yet another embodiment 501 illustrating an exemplary connection between the second actuator 57 and the waste processing system 10. In this embodiment, the second actuator 57 is mechanically connected to a hydraulic valve, wherein the hydraulic valve may operate one or more of the primary systems of the waste processing system 10: for example, feed system 26.

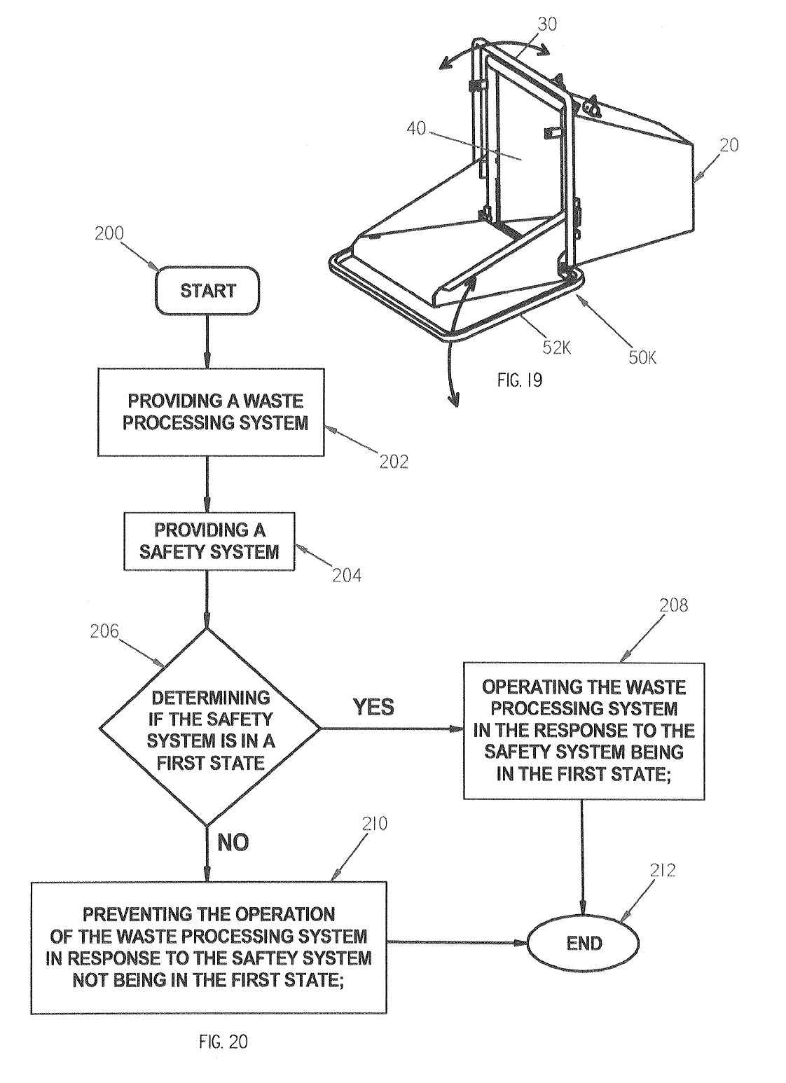

FIGS. 17 and 18 illustrate yet another embodiment 50J operable from both sides of infeed chute 20 wherein one or more actuators 52J are rotatable between and in-use position (FIG. 17) and a stored position (FIG. 18). Further, in this particular embodiment, an infeed tray 28 is rotatable between an in-use position (FIG. 17) and a stored position (FIG. 18), wherein the actuators 52J are operatively configured for operation and storage therewith. FIG. 19 illustrates yet another alternate embodiment 50K with actuator bar 52K.

As illustrated by FIG. 20, a method of operating a waste processing system is illustrated and includes the steps of: (202) providing a waste processing system 10 comprising a cutting system 18, a feed system 26, and a power system 24; (204) providing a safety and control system 50 comprising an actuator 52 adapted to permit operation of the cutting system 18, the feed system 26, and the power system 24 when the actuator 52 is in a first predetermined state, and adapted to interrupt operation of one or more of the cutting system 18, power system 24, and feed system 26 when the actuator 52 is in a second predetermined state. In operation then, in order to allow for normal operation of the waste processing system 10, actuator 52 must be positioned in a first predetermined state. For example, this first predetermined state may be associated with foot pedal 54 being depressed or moved from its original position, the original position being a second predetermined state. As such, upon determination (206) that the actuator 52 is in a first predetermined state, the cutting system, the feed system, and the power system are powered (208) and operated normally in response to the actuator being in the first predetermined state. However, if in a second predetermined state, e.g., when the pedal 54 is not depressed, the operation of at least one of the cutting system, the feed system, and the power system is interrupted (210). This operation of determining if actuator 52 is or is not within the first state may be repeated continuously and therefore, can be used as a safety device as well as a feed control device.

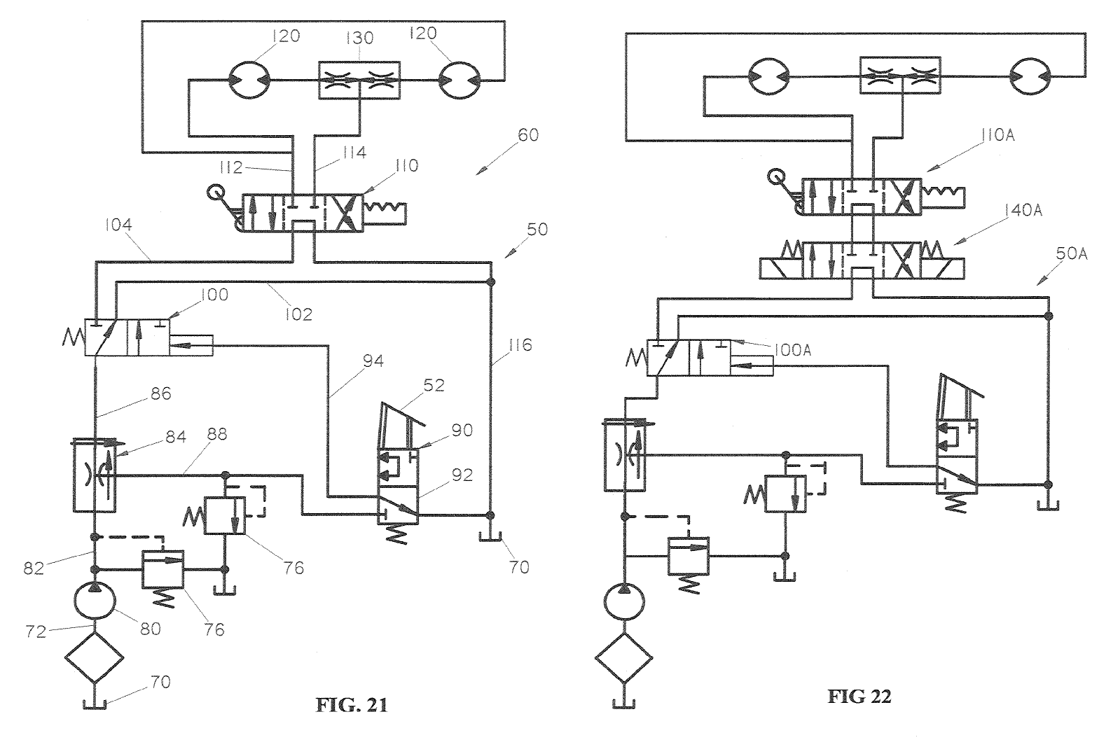

FIGS. 21-28 are diagrammatical representations of alternative embodiments of exemplary power systems for the safety and control system.

An exemplary circuit 60 is shown in FIG. 21 and includes a mechanical-hydraulic control system for safety and control system 50. Generally, control system 60 includes a pump 80, a safety and control system 50 comprising a control switch 90 and a control valve 100, a feed control valve 110, and one or more feed wheel motors 120 operatively connected to each other. For example, and with reference to the foot actuated device: the foot pedal 54 or (foot) actuator (bar) 52 actuates switch 90; thereby actuating valve 100; thereby allowing control of the feed wheel motors 120 (either directly or through the feed control bar 30 (via feed control valve 110).

More specifically, A storage tank 70 for hydraulic fluid is connected to pump 80 by a supply line 72. Exiting through pump 80 is supply line 82 which is in fluid connection with priority flow divider 84, which supplies lines 86 and 88. One or more pressure relief mechanisms 76 can be disposed along the lines 82 and 88 as needed. In this embodiment, priority flow divider 84 supplies line 88 with a portion of the main flow of hydraulic fluid to fluidly communicate with control switch 90. The remainder of the main flow from pump 80 is utilized in line 86 for powering the one or more feed wheels motors 120. For example only, if pump 80 is designed to deliver an output of 20 gallons per minute (GPM) at a pressure of 250 pounds per square inch (PSI), flow divider 84 may be designed so as to deliver 19.5 GPM to line 86 and 0.5 GPM to line 88.

As illustrated in FIG. 21, control switch 90 and control valve 100 are in an un-activated state. In this configuration, generally, fluid flows from tank 70 to control valve 100, to return line 102, and to tank 70′. In this manner the system does not have the required power (e.g., pressure or flow), for example in supply line 104, to allow for the operation of the feed wheel motors 120. Therefore, regardless of the position of feed control valve 110, the feed wheel motors 120 will not be driven or otherwise allowed to rotate. However, when control switch 90 is activated, via actuator valve 92 being moved to a position that fluidly connects line 88 with line 94, wherein line 94 is fluidly connected to control valve 100 for activation thereof. When control valve 100 is activated, line 86 is fluidly connected to line 104. With line 104 pressurized, operation of feed wheel motors 120 may be controlled by feed control valve 110 for neutral, foreword, or reverse movement.

Control switch 90 may be designed to be a momentary switch, so that control of the feed wheels depends upon, at least in part, switch 90; or a locked switch thereby allowing full control of the feed motors by the feed control valve 110, when locked. In one preferred embodiment, switch 90 is a normally un-activated (e.g., off) momentary switch wherein normal operation of the system 10 is allowed only when the actuator 52 is continuously actuated. Control of the system (e.g., feed wheel motors) is then accomplished through, in this particular embodiment, feed control valve 110 (via hand or upper feed control bar 30) and the system 50 will thereby operate as a safety device. However, the system 50 may also be configured to operate as a feed control device. Either in conjunction with the feed control 30 (if utilized) or separate thereto, the waste processing system 10 can be configured to utilize control switch 90 as a (lower) feed control. Exclusive control may be accomplished for example if the feed control valve 110 is either not utilized on the waste processing system 10 or is positionable to on “on” state and retainable therein. Otherwise, in conjunction with the feed control valve 110 being retained in a desired “on” state (e.g., forward or reverse via feed control bar 30), control switch 90 (for example via foot or lower feed control bar/actuator 52) can now operate as the primary feed control device. In the preferred embodiment, line 104 is connected to a conventional feed system 26 which comprises a control valve 110, a flow control/divider 130, and one or more feed wheel motors 120. The control valve 110 receives the flow from line 104 and controls the flow of fluid therethrough at a rate selected by the user. The control valve 110 includes a supply line 112 and a return line 114 which fluidly connects and extends between the control valve 110, the feed wheel motors 120, and the flow divider 130. In this particular embodiment, the flow divider 130 is disposed after the feed wheel motors and combines the supplied fluid to return line 114. When actuated, control valve 110 then fluidly connects line 114 to either return line 116 for forward operation, or supply line 104 for reverse operation thereof. Return conduit 116 extends to the tank 70′, thus completing the circuit. As noted above, the safety and control system 50 in one preferred embodiment is provided between the pump 80 and the feed system 26. However, the system may also be positioned between any power source and any other primary or sub-system. For example, between a power source and the cutting system 18, or between one or more power sources and one or more cutting systems 18 and feed systems 26. When the safety and control system 50 is adapted to control the rotation of the cutting system 18, the hydraulic schematic of this system may be substantially identical to that seen in FIG. 21, except that one or more cutting blade motors may be substituted for the one or more feed wheel motors. FIG. 22 illustrates a diagrammatical representation of an embodiment 50A, is similar to FIG. 21, and includes a system monitor valve 140A which may be adjusted or switched according to a system monitoring device (not shown), whereby one or more parameters of the waste processing system 10 may be monitored and adjusted. For example, the revolutions per minute (RPM) of the internal combustion engine 24 may be monitored in order to determine if the system 10 is operating within desired parameters. In one particular embodiment, the monitor valve 140A is disposed between the safety and control system 50A and the feed control 110A thereby controlling operation of the feed motors 120 based on the monitored status. As such, and again for example only, if it is determined that the engine speed (RPM) is low, the valve 140A may be activated to cut-off power to the feed wheel motors 120 until the engine speed (RPM) returns to a predefined level, at which point power may then be applied to the feed wheel motors 120 as described herein above. Of course, valve 140A may be operably positionable and, for example only, may be adapted to operate one or more primary or sub-systems in a forward, neutral, reverse, or any combination thereof, direction.

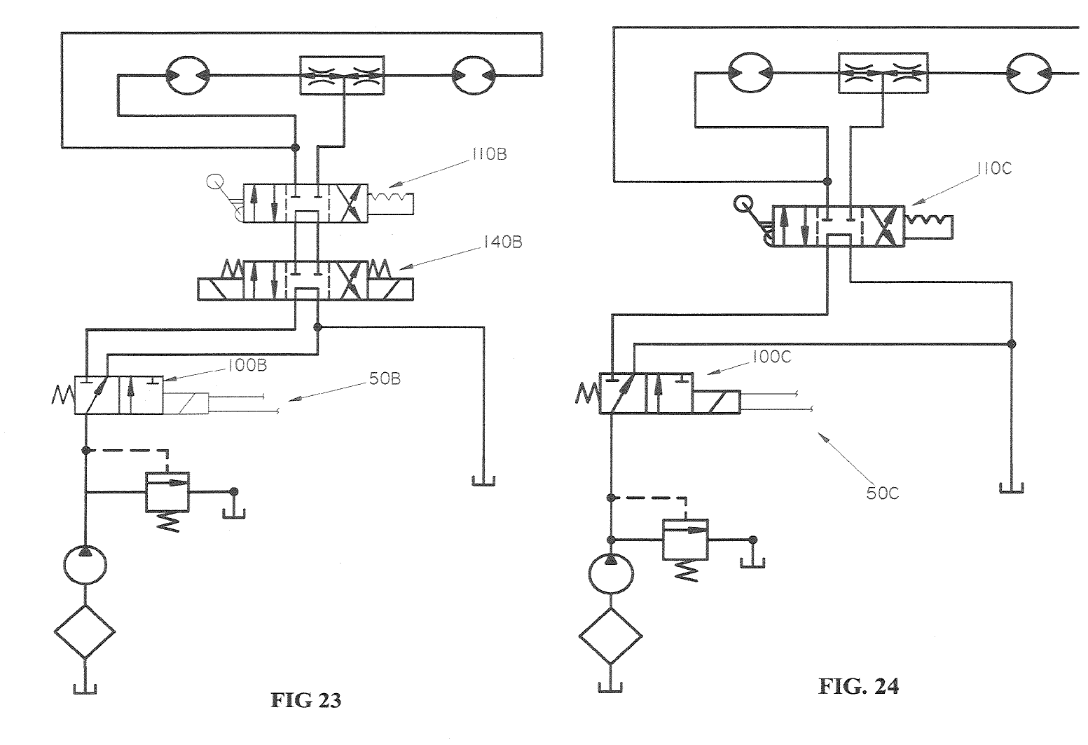

FIG. 23 illustrates a diagrammatical representation of an embodiment 50B and is similar to FIG. 22 wherein the mechanical-hydraulic configurations of FIGS. 21-22 are replaced with an electrical-hydraulic configuration. In this embodiment, control valve 100B is electrically operated, for example via a solenoid, rather than mechanically operated. The operation of the solenoid may be, for example, through an electrical foot switch. FIG. 24 illustrates a diagrammatical representation of an embodiment 50C similar to FIG. 23, without a system monitor valve.

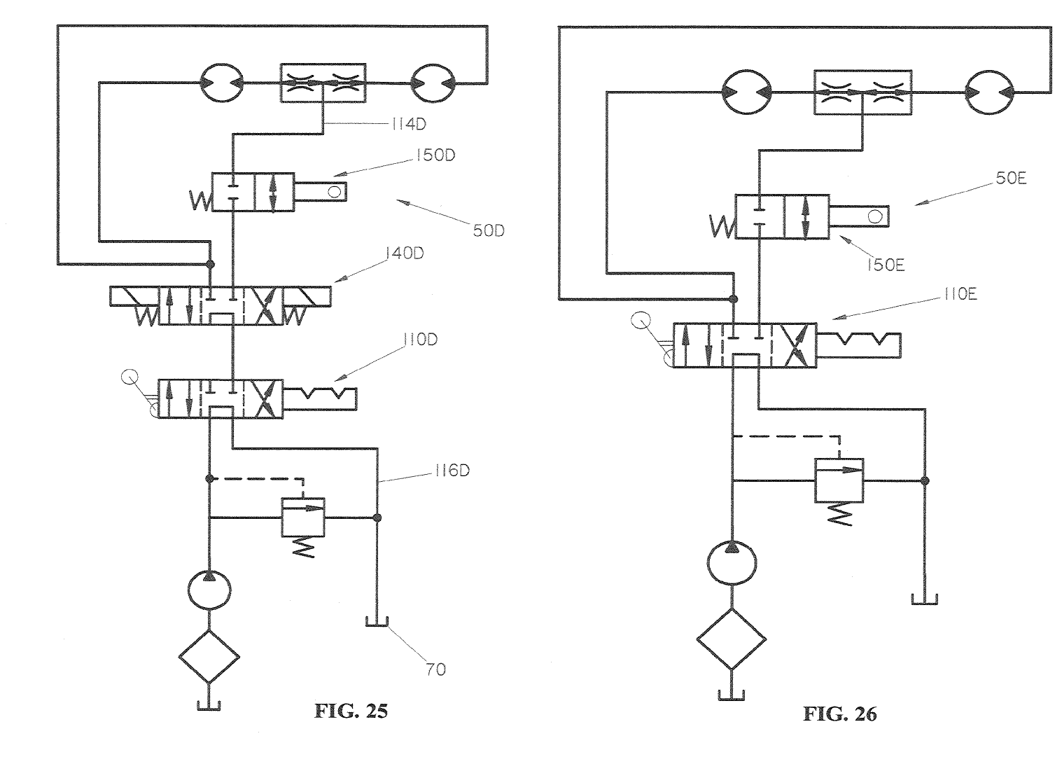

FIG. 25 illustrates diagrammatical representation of another embodiment 50D, wherein a mechanical valve 150D is disposed between return lines 114D and 116D. For example, this valve may operate by blocking and unblocking the fluid path from line 114D to tank 70′. Again, and for example only, the valve may be a mechanical valve that is operated via a foot actuated pedal (not shown). FIG. 26 illustrates a diagrammatical representation of an embodiment 50E similar to FIG. 25, without a system monitor valve.

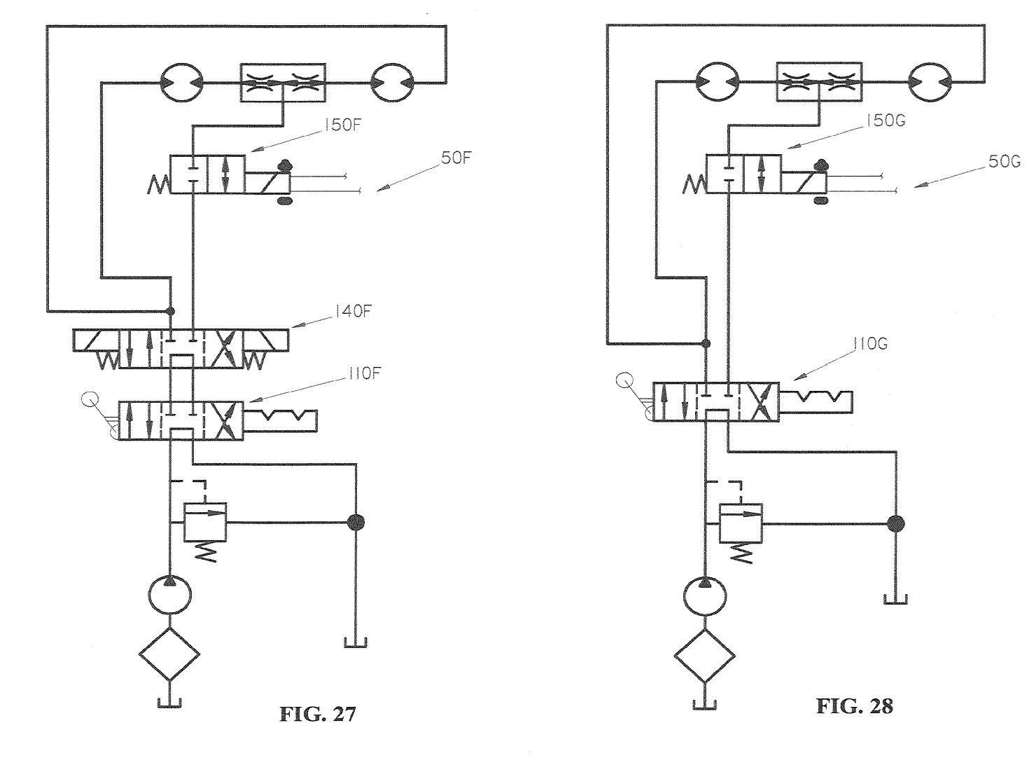

FIG. 27 illustrates a diagrammatical representation of an embodiment 50F similar to FIG. 25 wherein the mechanical-hydraulic configuration of FIG. 25 is replaced with an electrical-hydraulic configuration. In this embodiment, valve 150F is electrically operated, for example via a solenoid, rather than mechanically operated. The operation of the solenoid may be, for example, through an electrical foot switch. FIG. 28 illustrates a diagrammatical representation of an embodiment 50G similar to FIG. 27, without a system monitor valve.

To wit, an invention device, system and method has been disclosed wherein the system may be configured to increase the safety associated with the operation of, as well as the control of the waste processing system. In one particular embodiment, a novel device and system are disclosed which is conveniently located below the infeed chute and allows for the operation and/or control of the waste processing system via an operators foot. Further, in an emergency situation requiring the waste processing system to be quickly shut-off, the operator, either voluntarily or involuntarily, need only remove their foot from the device to activate the safety and/or control features.

While a linear sequence of events has been described, it should be appreciated that various modifications can be made therein and, as such, the system does not necessarily require a linear sequence of events. It is also to be understood that various modifications may be made to the system, it sequences, methods, orientations, and the like without departing from the inventive concept and that the description contained herein is merely a preferred embodiment and hence, not meant to be limiting unless stated otherwise.

Advantageously, the waste processing system of the present invention includes, among other advantages, the ability to increase safety, while priding a system and method that are simple, useful, and cost effective.

The solutions offered by the invention disclosed herein have thus been attained in an economical, practical, and facile manner. To wit, a novel waste processing system which is cost effective, easily configurable, and provides for increased operator safety and control has been invented. While preferred embodiments and example configurations of the inventions have been herein illustrated, shown, and described, it is to be appreciated that various changes, rearrangements, and modifications may be made therein, without departing from the scope of the invention as defined by the claims. It is intended that the specific embodiments and configurations disclosed herein are illustrative of the preferred and best modes for practicing the invention, and should not be interpreted as limitations on the scope of the invention as defined by the claims, and it is to appreciated that various changes, rearrangements, and modifications may be made therein, without departing from the scope of the invention as defined by the claims.

The invention claimed is:

1. A waste processing system comprising a cutting system and a feed system, wherein the improvement relates to a safety system which comprises:
an actuator having at least two operable positions, the actuator in communication with the waste processing system and adapted to selectively control the operation thereof;
wherein the actuator is positionable about the waste processing system.

2. The waste processing system as set forth in claim 1, wherein:
the actuator is adapted to be actuated by an operators foot.

3. The waste processing system as set forth in claim 1, wherein:
the actuator comprises a foot pedal.

4. The waste processing system as set forth in claim 3, wherein:
the actuator is mounted to an infeed chute.

5. The waste processing system as set forth in claim 4, wherein:
the actuator is pivotally mounted to the infeed chute and comprises a storage position and a use position.

6. The waste processing system as set forth in claim 1, wherein:
the actuator is a foot activated bar.

7. The waste processing system as set forth in claim 1, wherein:
the actuator is in mechanical communication with the waste processing system.

8. The waste processing system as set forth in claim 1, wherein:
the actuator is operably connected electronically with at least one of the feed system, the cutting system, and a power system.

9. The waste processing system as set forth in claim 1, wherein:
the actuator is operably connected hydraulically with at least one of the feed system, the cutting system, and the a power system.

10. The waste processing system as set forth in claim 1, wherein:
the actuator is adapted to move between a first predetermined state and a second predetermined state.

11. The waste processing system as set forth in claim 10, wherein:
the actuator is adapted to permit operation of the cutting system and the feed system when the actuator is in the first predetermined state, and the actuator is adapted to interrupt operation of at least one of the feed system and the cutting system when the actuator is in the second predetermined state.

12. The waste processing system as set forth in claim 11, wherein:
upon the actuator moving from the first to the second predetermined state and interrupting operation of the at least one of the feed system and the cutting system, the waste processing system is adapted to require an operation by an operator, other than the actuator being switched from the second to the first predetermined state, in order to restore operation.

13. The waste processing system as set forth in claim 10, wherein:
the actuator is adapted to permit operation of the cutting system and the feed system when the actuator is in the first predetermined state, and the actuator is adapted to interrupt operation of the cutting system and to permit operation of the feed system in a reverse direction when the actuator is in the second predetermined state.

14. The waste processing system as set forth in claim 10, wherein:
the actuator is operably connected to a diverter valve adapted to redirect a flow of hydraulic fluid from at least one of the feed system and the cutting system toward a hydraulic reservoir when the actuator is in the second predetermined state.

15. The waste processing system as set forth in claim 10, wherein:
the actuator is adapted to permit operation of a feed control bar when the actuator is in the first predetermined state and the actuator is adapted to interrupt operation of the feed control bar when in the second predetermined state.

16. The waste processing system as set forth in claim 1, wherein:
the actuator comprises a normally open momentary switch.

17. The waste processing system as set forth in claim 10, wherein:
the actuator is adapted to restrict operation of at least one of the cutting system and the feed system when the actuator is in the second predetermined state.

18. The waste processing system as set forth in claim 10, wherein:
the actuator is adapted to permit operation of at least one of the cutting system and the feed system when the actuator is in the first predetermined state.

19. The waste processing system as set forth in claim 10, wherein:
the actuator is adapted to selectively control operation of at least one of the cutting system and the feed system when the actuator is in the first predetermined state.

20. The waste processing system as set forth in claim 10, wherein:
the actuator is adapted to selectively restrict operation of a feed control bar when the actuator is in the second predetermined state.

21. The waste processing system as set forth in claim 10, wherein:
the actuator is adapted to selectively control a feed control bar to permit operation of both the cutting system and the feed system when the actuator is in the first predetermined state, and to interrupt at least one of the feed system and the cutting system when the actuator is in the second predetermined state.

22. The waste processing system as set forth in claim 10, wherein:
the actuator is operably connected to at least one of the cutting system and the feed system to allow operation of the at least one of the cutting system and the feed system when the actuator is in the first predetermined state, and the actuator is operably connected to at least one of the cutting system and the feed system to interrupt operation of the at least one of the cutting system and the feed system when the actuator is in the second predetermined state.

23. The waste processing system as set forth in claim 1, wherein:
the waste processing system comprises a wood chipper.

24. The waste processing system as set forth in claim 1, wherein:
the actuator is hand held.

25. The waste processing system as set forth in claim 1, wherein:
the actuator is wirelessly in communication with the waste processing system.

26. The waste processing system as set forth in claim 1, wherein:
the actuator is movable about the waste processing system.

27. A waste processing system comprising a cutting system and a feed system, wherein the improvement relates to a safety system which comprises:
an actuator, the actuator disposed on the waste processing system below a horizontal reference line defined by a top of an infeed chute, the actuator having at least two operable positions and operably connected with the waste processing system to allow operation of the waste processing system upon positioning the actuator in a first position.

28. The waste processing system as set forth in claim 27, further comprising:
wherein the actuator is normally biased to a second position and the first position must be manually maintained in the first position.

29. The waste processing system as set forth in claim 27, further comprising:
wherein the actuator is normally biased to a second position and the first position must be continuously maintained in the first position.

30. The waste processing system as set forth in claim 29, wherein:
the actuator is disposed below a bottom of the infeed chute.

31. The waste processing system as set forth in claim 29, wherein:
the actuator is adapted to be actuated by an operators foot.

32. A waste processing system comprising a cutting system and a feed system, wherein the improvement relates to a safety system which comprises:
an actuator, the actuator disposed on the waste processing system below a horizontal reference line defined by a top of an infeed chute, the actuator having at least two operable positions and operably connected with the waste processing system and adapted to selectively control operation thereof.

33. The waste processing system as set forth in claim 32, wherein:
the actuator is operably connected with at least one of the cutting system and the feed system to restrict operation of the at least one of the cutting system and the feed system when the actuator is in one of the two operable positions.

34. The waste processing system as set forth in claim 33, wherein:
the actuator is adapted to be foot actuated.

35. The waste processing system as set forth in claim 34, wherein:
the actuator is mounted to an infeed chute of the waste processing system and extends at least partially therebelow.

36. The waste processing system as set forth in claim 35, wherein:
the actuator is positionable in a first position wherein the actuator extends at least partially below the infeed chute of the waste processing system, and a second position wherein the actuator does not extend below the infeed chute.

37. The waste processing system as set forth in claim 34, wherein:
the actuator is disposed below a bottom of the infeed chute.

38. A wood chipper comprising:
A foot activated actuator having at least two operable positions;
the foot activated actuator operably connected with at least one of a cutting system and a feed system to restrict operation of the at least one of the cutting system and the feed system when the foot activated actuator is in one of the two operable positions.

39. The wood chipper as set forth in claim 38, wherein:
the foot activated actuator is positionable.

40. The wood chipper as set forth in claim 39, wherein:
the foot activated actuator is positionable on a ground surface.

41. The wood chipper as set forth in claim 38, wherein:
the foot activated actuator is a pressure mat.

42. A wood chipper comprising:
an infeed chute and a discharge chute;
a feed system disposed between the infeed chute and the discharge chute;
a cutting system disposed between the feed system and the discharge chute; and
a remotely positionable actuator configured to shut off at least one of the feed system, the cutting system, and a power system.

43. A method of operating a waste processing system comprising:
providing a waste processing system comprising a cutting system, a feed system, and a power system;
providing a safety system comprising an actuator disposed on the waste processing system below a horizontal reference line defined by a top of an infeed chute and adapted to permit operation of the cutting system, the feed system, and the power system when the actuator is in a first predetermined state, and adapted to interrupt operation of at least one of the cutting system, the feed system, and the power system when the actuator is in a second predetermined state;
positioning the actuator in the first predetermined state;
operating the cutting system, the feed system, and the power system in response to the actuator being in the first predetermined state;
interrupting operation of at least one of the cutting system, the feed system, and the power system in response to the actuator being in the second predetermined state.

44. The method of operation according to claim 43, further comprising:
requiring that the actuator be maintained in the first predetermined state for operation of the cutting system, the feed system, and the power system.

45. The method of operation according to claim 43, further comprising:
remotely locating the safety system.

46. The method of operation according to claim 43, wherein:
the providing step further includes providing a foot activated actuator.

47. A method of operating a waste processing system comprising:
providing a waste processing system comprising a cutting system, a feed system, and a power system;
providing a safety system comprising a foot activated actuator adapted to permit operation of the cutting system, the feed system, and the power system when the foot activated actuator is in a first predetermined state, and adapted to interrupt operation of at least one of the cutting system, the feed system, and the power system when the foot activated actuator is in a second predetermined state;
determining if the foot activated actuator is in the first predetermined state or the second predetermined state;
operating the cutting system, the feed system, and the power system in response to the actuator being in the first predetermined state and requiring that the actuator be continuously maintained in the first predetermined state for operation thereof; and
interrupting operation of at least one of the cutting system, the feed system, and the power system in response to the actuator being in the second predetermined state.

48. A waste processing system comprising a cutting system and a feed system, wherein the improvement relates to a lower feed control bar which comprises:
a lower feed control bar disposed below a horizontal plane defined by a top of an infeed chute, the lower feed control bar operably attached to an actuator having at least two operable positions, the actuator in communication with the waste processing system and adapted to selectively control the operation thereof.

49. The waste processing system as set forth in claim 48, wherein:
the actuator is adapted to control the feed system.

50. The waste processing system as set forth in claim 48, wherein:
The lower feed control bar is mounted below the infeed chute.

51. The waste processing system as set forth in claim 48, wherein:
the lower feed control bar is disposed on the waste processing system so as to be operated by an operators foot.

52. The waste processing system as set forth in claim 48, wherein:
the lower feed control bar comprises a single pivot.

53. A control for a waste processing system comprising a cutting system and a feed system, the control comprising:
an actuator, the actuator adapted to be mountably disposed below a horizontal plane defined by a top of an infeed chute, the actuator having at least two operable positions;
the actuator adapted to communicate with at least one of a cutting system and a feed system of a waste processing system for selective control thereof.

54. The control as set forth in claim 53, wherein:
the actuator is adapted to be foot actuated.

55. A control for use in combination with an existing waste processing system comprising a cutting system and a feed system, the control comprising:
an actuator, the actuator adapted to be mountably disposed below a horizontal plane defined by a top of an infeed chute of an existing waste processing system, the actuator having at least two operable positions;
the actuator adapted to communicate with at least one of a cutting system and a feed system of a waste processing system for selective control thereof when installed thereon;
wherein the actuator is adapted to be normally biased to a second position, whereas a first position must be continuously maintained by an operator for operation of the existing waste processing system.

56. The control as set forth in claim 55, wherein:
the actuator is adapted to be foot actuated.
